(19) United States
(12) Patent Application Publication
(10) Pub. No.: US 2007/0261679 A1
(43) Pub. Date: Nov. 15, 2007

(54) ACTIVE PURGE METHOD FOR SMALL ENGINE EQUIPMENT

(76) Inventor: Michael F. Tschantz, Lexington, VA (US)

Correspondence Address: MEADWESTVACO CORPORATION, 1021 MAIN CAMPUS DRIVE, 3RD FLOOR, CENTENNIAL CAMPUS, RALEIGH, NC, 27606, US

(21) Appl. No.: 11/735,557

(22) Filed: Apr. 16, 2007

Related U.S. Application Data
(60) Provisional application No. 60/747,036, filed on May 11, 2006.

(51) Int. Cl. F02M 33/02

(52) U.S. Cl. 123/520

(57) ABSTRACT

An emissions control system is described for an internal combustion engine, having a vapor sorbent material within the fuel tank cap subjected to an active purge.

This non-provisional application relies on the filing date of provisional U.S. Application Ser. No. 60/747,036 filed on May 11, 2006, which is incorporated herein by reference, having been filed within twelve (12) months thereof, and priority thereto is claimed under 35 USC §119(e).

### BACKGROUND

The use of sorbtion materials (sorbents) such as activated carbon to remove contaminants from air is well known. Specialized activated carbons have been developed for example as described by U.S. Pat. No. 5,538,929 which discloses a phosphorus-treated activated carbon. Sorbents may be placed within suitable air-handling systems to clean the air passing through the material. Such systems are sometimes known as vapor adsorbers.

Another well known sorbent use is for capturing hydrocarbon vapors that would otherwise escape from the fuel systems of internal combustion engines. An example is a sorbent canister suitably placed in an automobile to trap gasoline vapors that might otherwise escape from the gasoline tank or from engine components, particularly during periods of non-use.

U.S. Pat. No. 6,959,696 discloses both an actively purged canister and a passively purged canister for small internal combustion engines. The actively purged design embodies a carbon canister that is connected by a tube to the throttle body of the internal combustion engine that induces airflow.

### SUMMARY

This invention relates to a method of providing vapor emissions control for small engines, using a sorbent contained in the cap of the fuel tank.

### BRIEF DESCRIPTION OF THE DRAWINGS

FIG. 1 illustrates a fuel tank having an emissions control device according to the invention.

### DETAILED DESCRIPTION

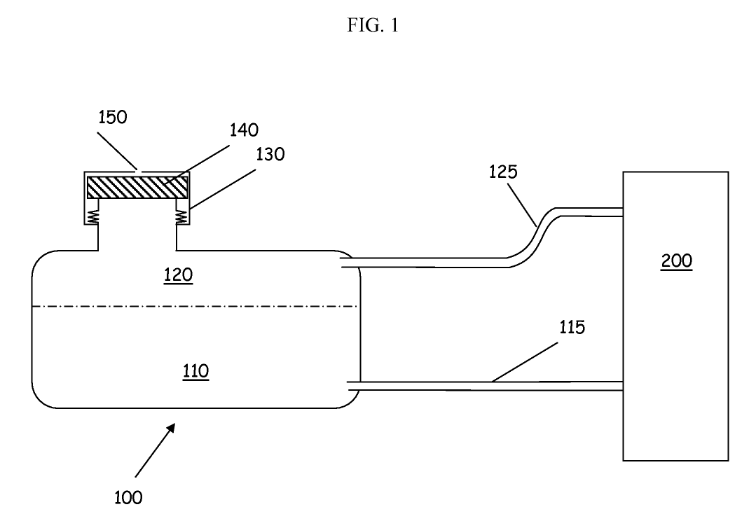

FIG. 1 illustrates a cross section view of a fuel tank 100 showing the tank partially filled with fuel 110, and above the fuel, a vapor space 120. Liquid fuel from tank 100 may be conveyed through fuel line 115 to an internal combustion engine 200. Details of the internal combustion engine are not shown, but are well known to those skilled in the art. Fuel delivered through fuel line 115 will typically pass through components (not shown) such as a filter, a fuel pump, and a fuel injection or carburetion system. Some of these components may be contained within fuel tank 100, such as a filter or a pump. There may be an additional fuel recirculation line (not shown).

Fuel tank 100 is provided with a fuel cap 130, which has a vent such as a hole 150 to allow pressure within the tank to be released to the atmosphere. To prevent fuel vapors from reaching the atmosphere, a sorbent material 140 is provided within gas cap 130. The sorbent material may, for example, be activated carbon.

When the fuel tank 100 heats up, for example during the day, gases within the vapor space 120 expand and pass through the cap 130 must first pass through sorbent 140, which adsorbs fuel vapors. When the fuel tank cools, for example at night, the pressure within the fuel tank reduces and fresh air comes in through hole 150, passing through the sorbent 140 and entering the fuel tank 100. As the fresh air is drawn in through the sorbent 140, it removes some of the adsorbed fuel from the sorbent 140, restoring it within the vapor space 120. Such purging is termed “passive purging.”

It would be useful if the sorbent 140 could be purged actively. To accomplish this, according to the invention, during operation of engine 200, vapors 120 are drawn through purge line 125 and into a low pressure point in the engine, for example a venturi point or other reduced pressure location within the engine air intake system, such as within the throttle body. When the engine is operating, airflow is induced through the purge line 125, which causes air to enter the tank through the gas cap and vent hole 150, and purge sorbent 140, sweeping gas vapor from the sorbent, and delivering it to the combustion chamber of the engine.

With the invention disclosed herein, the purge line is connected to and draws air from the fuel tank, which in turn draws air through the sorbent device located within the fuel cap. The sorbent device itself is not connected to the purge line.

The invention uses a sorbent device or canister that is fitted to a fuel tank. The sorbent device or canister could be part of the screw cap, or could be a separate device. A fuel cap containing a sorbent is currently marketed by ITW Fastex, but it does not have a means to actively purge the sorbent.

Methods of making and using the emission control system in accordance with the invention should be readily apparent from the mere description of the structure and its varied appearances as provided herein. No further discussion or illustration of such methods, therefore, is deemed necessary.

While preferred embodiments of the invention have been described and illustrated, it should be apparent that many modifications to the embodiments and implementations of the invention can be made without departing from the spirit or scope of the invention. It is to be understood therefore that the invention is not limited to the particular embodiments disclosed (or apparent from the disclosure) herein, but only limited by the claims appended hereto.

What is claimed as new and desired to be protected by Letters Patent of the United States is:

1. An emission control system for an internal combustion engine, comprising
a fuel tank for storing fuel and containing a vapor space above said fuel,
a fuel supply line between said fuel tank and said engine,
a cap for said fuel tank, said cap comprising air inlet means and adsorbent material for adsorbing fuel vapors, and
a purge line between vapor space of said fuel tank and a point of low pressure in said engine.

2. An emission control system for an internal combustion engine, comprising
a fuel tank for storing fuel and containing a vapor space above said fuel,
a fuel supply line between said fuel tank and said engine,
a cap for said fuel tank, said cap comprising air inlet means and adsorbent material for adsorbing fuel vapors,
a purge line between vapor space of said fuel tank and a point of low pressure in said engine, and
a sorbent material for adsorbing fuel vapors connected to said cap and outside of said fuel tank.

3. The emission control system of claim 1, wherein during operation of said engine, air flow may be drawn from the outside atmosphere via air inlet means through said sorbent material, then through said vapor space of said fuel tank, then through said purge line to said low pressure point in said engine.

4. The emission control system of claim 2, wherein during operation of said engine, air flow may be drawn from the outside atmosphere via air inlet means through said sorbent material, then through said vapor space of said fuel tank, then through said purge line to said low pressure point in said engine
